(19) United States
(12) Patent Application Publication
(10) Pub. No.: US 2015/0302000 A1
(43) Pub. Date: Oct. 22, 2015

(54) A METHOD AND A TECHNICAL EQUIPMENT FOR ANALYSING MESSAGE CONTENT

(71) Applicants: Hongrui SHEN, (US); Naichen CUI, (US); Lu LIU, (US); Minghui ZHANG, (US)

(72) Inventors: Hongrui Shen, Beijing (CN); Naichen Cui, Beijing (CN); Lu Liu, Beijing (CN); Minghui Zhang, Beijing (CN)

(21) Appl. No.: 14/443,831

(22) PCT Filed: Nov. 30, 2012
(86) PCT No.: PCT/CN2012/085614

§ 371 Date: May 19, 2015

(51) Int. Cl. G06F 17/27; H04L 12/58

(52) U.S. Cl. CPC G06F 17/2765; H04L 51/34; H04W 4/14

(57) ABSTRACT

The present embodiments relate to a method and a technical equipment for implementing the method. The method comprises receiving a message; identifying an action request from the message; determining a keyword from the message; monitoring the requested action, and detecting a data item relating to the action; and associating the keyword with the detected data item.

### TECHNICAL FIELD

The present embodiments relate to a method and a technical equipment for analyzing message content.

### BACKGROUND

Since mobile phones having short messaging (i.e. text messaging) capability were developed, short messaging service (SMS) has maintained its popularity among other messaging services, such as multimedia message, email, instant message etc. Short messages are text-based, whereas multimedia message contains also other content than text. Short messages are used for informing the recipient on something, requesting the recipient to do something, sending greetings etc.

From very early days of short messaging service, there has been an ambition to automatic content recognition of short messages. This has been realized with detecting a string of numbers corresponding to a telephone number or an at-sign (@) corresponding to an email address. However, not all the number strings refer to a telephone number, as well as not all the @-signs refer to an email address. Therefore an improved solution for interpreting a content of a message is needed.

### SUMMARY

Now there has been invented an improved method and technical equipment implementing the method, for addressing said need. Various aspects of the invention include a method, an apparatus, a system and a computer readable medium comprising a computer program stored therein, which are characterized by what is stated in the independent claims. Various embodiments of the invention are disclosed in the dependent claims.

According to a first aspect, a method comprises receiving a message; identifying an action request from the message; determining a keyword from the message; monitoring the requested action, and detecting a data item relating to the action; and associating the keyword with the detected data item.

According to a second aspect, an apparatus comprises at least one processor, memory including computer program code, the memory and the computer program code configured to, with the at least one processor, cause the apparatus to perform at least the following: receiving a message; identifying an action request from the message; determining a keyword from the message; monitoring the requested action, and detecting a data item relating to the action; and associating the keyword with the detected data item.

According to a third aspect, a system comprises at least one processor, memory including computer program code, the memory and the computer program code configured to, with the at least one processor, cause the system to perform at least the following: receiving a message; identifying an action request from the message; determining a keyword from the message; monitoring the requested action, and detecting a data item relating to the action; and associating the keyword with the detected data item.

According to a fourth aspect, an apparatus comprises means for receiving a message; means for identifying an action request from the message; means for determining a keyword from the message; means for monitoring the requested action, and detecting a data item relating to the action; and means for associating the keyword with the detected data item.

According to a fifth aspect, a computer program product embodied on a non-transitory computer readable medium, comprising computer program code configured to, when executed on at least one processor, cause an apparatus or a system to: receive a message; identify an action request from the message; determine a keyword from the message; monitor the requested action, and detecting a data item relating to the action; and associate the keyword with the detected data item.

According to an embodiment, when a keyword is determined from the message, a data item matching to the keyword is looked for, and if not found, the requested action is monitored to perform the association.

According to an embodiment, if a data item matching the keyword is found, means to perform said action with the data item is provided automatically.

According to an embodiment, the action request relates to one of the following actions: call; send; reply; meet; go; see; email.

According to an embodiment, the keyword is a character string.

According to an embodiment, the data item is one of the following: a piece of information in a contact card; a media file; a location.

According to an embodiment, the keyword is stored as an associating data to a metadata of the data item.

According to an embodiment, the message is one of the following: short message, multimedia message, instant message, email, voice mail.

### DESCRIPTION OF THE DRAWINGS

In the following, various embodiments of the invention will be described in more detail with reference to the appended drawings, in which

FIG. 1 shows an apparatus according to an embodiment;

FIG. 2 shows a layout of an apparatus according to an embodiment;

FIG. 3 shows a network system comprising an apparatus according to an embodiment;

FIG. 4 shows an apparatus according to another embodiment;

FIG. 5 shows a method according to an embodiment as a flowchart;

FIG. 6 shows an apparatus according to yet another embodiment;

FIG. 7 shows a method according to another embodiment as a flowchart;

FIG. 8 shows an apparatus according to yet another embodiment;

FIG. 9 shows a method according to yet another embodiment as a flowchart;

FIG. 10 shows an apparatus according to yet another embodiment;

FIG. 11 shows a method according to yet another embodiment as a flowchart; and

FIG. 12 shows an example of a user interface views for an apparatus according to an embodiment.

### DESCRIPTION OF EXAMPLE EMBODIMENTS

In the following, several embodiments of the invention will be described in the context of short messaging. It is to be noted, however, that the invention is not limited to short messaging. In fact, the different embodiments have applications in any environment where content analysis is required, for example other messaging applications such as multimedia messaging, email, instant messaging, voice messaging.

In the following, a smart phone is used as an example of the apparatus. However, the apparatus may be any computerized device having a data transmission capability. In addition to the data transmission capability, the apparatus comprises or is connected to means for providing calling services. Other examples of the apparatus are mobile phone, laptop device, tablet device.

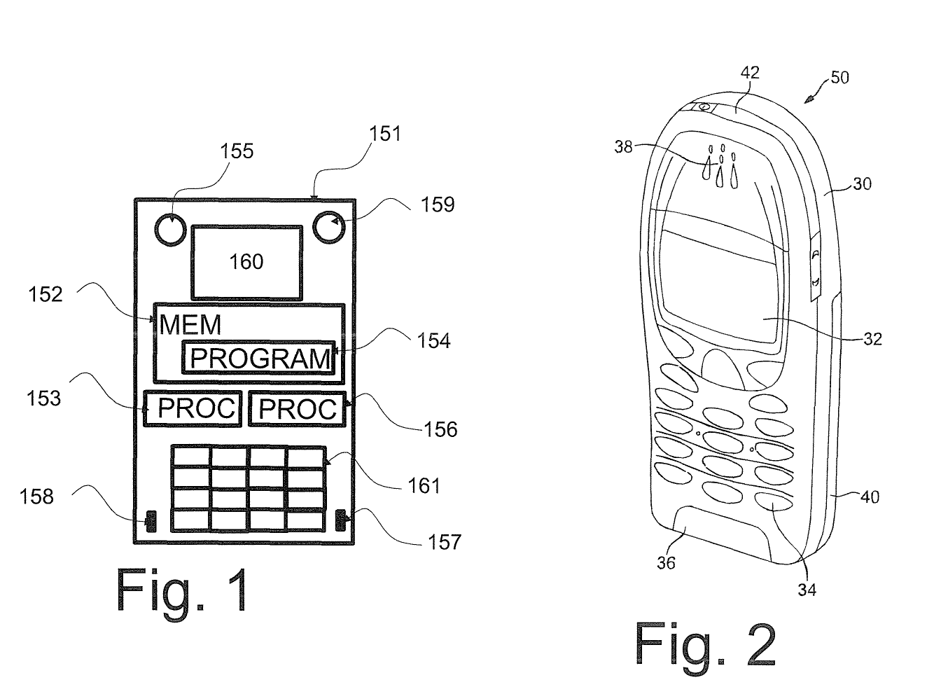

FIG. 1 illustrates and example of the apparatus. The apparatus 151 contains memory 152, at least one processor 153 and 156, and computer program code 154 residing in the memory 152. The apparatus according to the example of FIG. 1, also has one or more cameras 155 and 159 for capturing image data, for example stereo video. The apparatus of this example also contains one, two or more microphones 157 and 158 for capturing sound. The apparatus may also contain sensor for generating sensor data relating to the apparatus' relationship to the surroundings. The apparatus also comprises a display 160 for viewing single-view, stereoscopic (2-view) or multiview (more-than-2-view) images. The display 160 may be extended at least partly on the back cover of the apparatus. The apparatus 151 also comprises an interface means (e.g. a user interface) which allows a user to interact with the apparatus. The user interface means is implemented either using one or more of the following: the display 160, a keypad 161, voice control, or other structures. The apparatus is configured to connect to another device e.g. by means of a communication block (not shown in FIG. 1) able to receive and/or transmit information.

FIG. 2 shows a layout of an apparatus according to an example embodiment. The electronic device 50 is for example a mobile terminal (e.g. mobile phone, a smart phone, a camera device, a tablet device) or other user equipment of a wireless communication system. Embodiments of the invention may be implemented within any electronic device or apparatus, such a personal computer and a laptop computer.

The apparatus 50 shown in FIG. 2 comprises a housing 30 for incorporating and protecting the device. The apparatus 50 further comprises a display 32 in the form of e.g. a liquid crystal display. In other embodiments of the invention the display is any suitable display technology suitable to display an image or video. The apparatus 50 further comprises a keypad 34 or other data input means. In other embodiments of the invention any suitable data or user interface mechanism may be employed. For example the user interface may be implemented as a virtual keyboard or data entry system as part of a touch-sensitive display. The apparatus comprises a microphone 36 or any suitable audio input which may be a digital or analogue signal input. The apparatus 50 further comprises an audio output device which in embodiments of the invention may be any one of: an earpiece 38, speaker, or an analogue audio or digital audio output connection. The apparatus 50 of FIG. 2 also comprises a battery 40 (or in other embodiments of the invention the device may be powered by any suitable mobile energy device such as solar cell, fuel cell or clockwork generator). The apparatus according to an embodiment comprises an infrared port 42 for short range line of sight communication to other devices. In other embodiments the apparatus 50 may further comprise any suitable short range communication solution such as for example a Bluetooth wireless connection or a USB/firewire wired connection.

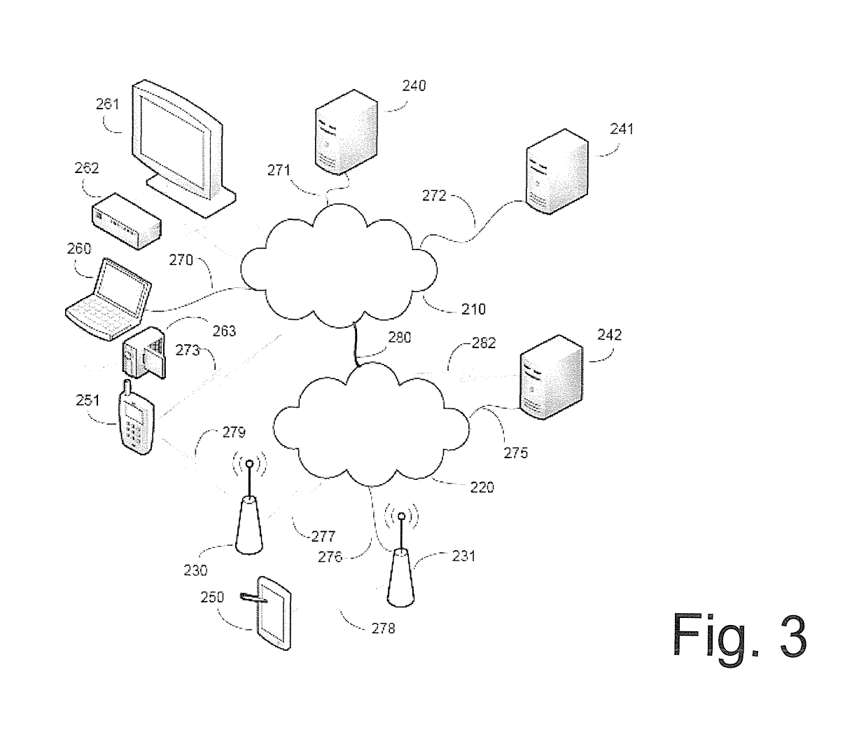

FIG. 3 shows a system, where the apparatus is able to function. In FIG. 3, the different devices may be connected via a fixed network 210 such as the Internet or a local area network; or a mobile communication network 220 such as the Global System for Mobile communications (GSM) network, 3rd Generation (3G) network, 3.5th Generation (3.5G) network, 4th Generation (4G) network, Wireless Local Area Network (WLAN), Bluetooth®, or other contemporary and future networks. Different networks are connected to each other by means of a communication interface 280. The networks comprise network elements such as routers and switches to handle data (not shown), and communication interfaces such as the base stations 230 and 231 in order for providing access for the different devices to the network, and the base stations 230, 231 are themselves connected to the mobile network 220 via a fixed connection 276 or a wireless connection 277.

There may be a number of servers connected to the network, and in the example of FIG. 1 are shown servers 240, 241 and 242, each connected to the mobile network 220, which servers, or one of the servers, may be arranged to operate as computing nodes (i.e. to form a cluster of computing nodes or a so-called server farm) for a social networking service. Some of the above devices, for example the computers 240, 241, 242 may be such that they are arranged to make up a connection to the Internet with the communication elements residing in the fixed network 210.

There are also a number of end-user devices such as mobile phones and smart phones 251 for the purposes of the present embodiments, Internet access devices (Internet tablets) 250, personal computers 260 of various sizes and formats, and computing devices 261, 262 of various sizes and formats. These devices 250, 251, 260, 261, 262 and 263 can also be made of multiple parts. In this example, the various devices are connected to the networks 210 and 220 via communication connections such as a fixed connection 270, 271, 272 and 280 to the Internet, a wireless connection 273 to the internet 210, a fixed connection 275 to the mobile network 220, and a wireless connection 278, 279 and 282 to the mobile network 220. The connections 271-282 are implemented by means of communication interfaces at the respective ends of the communication connection. All or some of these devices 250, 251, 260, 261, 262 and 263 are configured to access a server 240, 241, 242 and a social network service.

As said, the apparatus comprises a memory. In addition to computer programs, the memory is configured to store a contact list containing connections with contact and/or personal information, e.g. any combination of the following: telephone number, email address, visiting address, personal photo, birthday, etc. The smart phone is also configured to receive messages, in the form of e.g. short message, multimedia message, email and/or instant message.

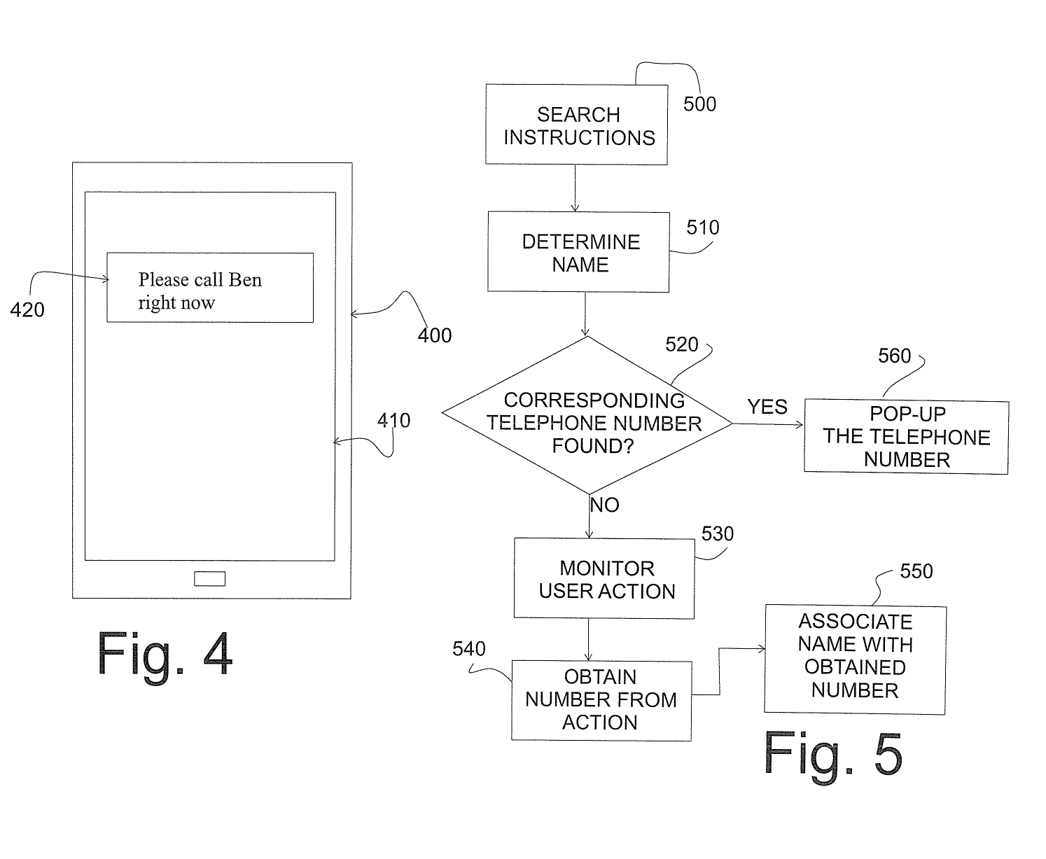

FIG. 4 shows an example of a short message. In this example the message (420) is “Please call Ben right now” as shown on a display (410) of the smart phone (400).

When such a message is received, the apparatus analyses the content of the message. At first, instructions (i.e. action request) from the message content are searched for (500). In order to do this, an action database may be utilized for keyword finding. Such an action database may contain action names with or without synonyms for actions typically performed by a user with the apparatus. However, in order to avoid semantics mistake, also pattern recognition algorithm is used. When such a pattern recognition algorithm is used, a message “Call Ben right now” is taken for further analysis, whereby a message “This is a wrong call” is not taken for further analysis.

In the above message, shown in FIG. 4, the instruction is “call”. However, by using only the message as a guide for performing the calling action, the calling is not possible because the message does not contain any numbers.

In order to search the number from the contact list, a match with Ben is looked for (510). In this example, the contact list contains following contacts:

| | |
|---|---|
| Bensun, Mary | Tel: 457 2554 39 |
| Downhill, Albert | Tel: 125 6842 47 |
| Holm, Ken | Tel: 548 2754 65 |
| May, Judith | Tel: 258 5647 11 |
| Orrel, Benjamin | Tel: 875 5462 45 |
| Twist, Keith | Tel: 124 5852 75 |

It is realized that the list does not contain a contact “Ben”, but contains names having a string “ben” (i.e. “Bensun”, “Benjamin”). If a direct string matching was used, the analysis would return both “Mary Bensun” and “Benjamin Orrel” as a target for calling. In such a case, the user needs to select which one to use.

However, by means of present embodiments, the analysis is able to provide only the correct contact information. This is because the analysis is based on an association method being performed at the time a previous message with similar content was received.

The basis for the analysis is associating a data element in a received message to a data item on the apparatus. The data element in the message can be a text string, which is matched to a file (e.g. contact file, music file, video file, a sensor data) by means of user action. Thus, e.g. a contact information can be automatically expanded to include also e.g. nicknames, or even to automatically create a new contact card.

The associating method is described next. When a message is received for the first time, e.g. “Please call Ben right now”, it is detected that the message contains a name “Ben”. Because the name “Ben” is not explicitly mentioned in the contact list, the next action is to monitor user's action (530). The next call the user is making, is supposed to be to Ben's number. If the user selects “Benjamin Orrel” as a target for a call after receiving the message, the apparatus is configured to associate “Ben” to “Benjamin Orrel” (540-550). The apparatus may modify the contact card, so that the card of “Benjamin Orrel” is complemented with string “Ben”.

If a user does not select any contact from the contact list, but selects a certain number “1234 987” to which the call is made, the apparatus is configured to determine that the contact information of “Ben” is “1234 987” and associate Ben to that number (540-550). As a result of this, the apparatus may create a new contact card to the contact list for “Ben 1234 987”. The user may modify this afterwards if needed.

As a result of this, next time the user receives a message “Call to Ben”, the apparatus is able to obtain the associated contact information for “Ben”, and to provide it together with the call action to the user on the user interface of the smartphone.

The previous association method can be applied to other user cases as well.

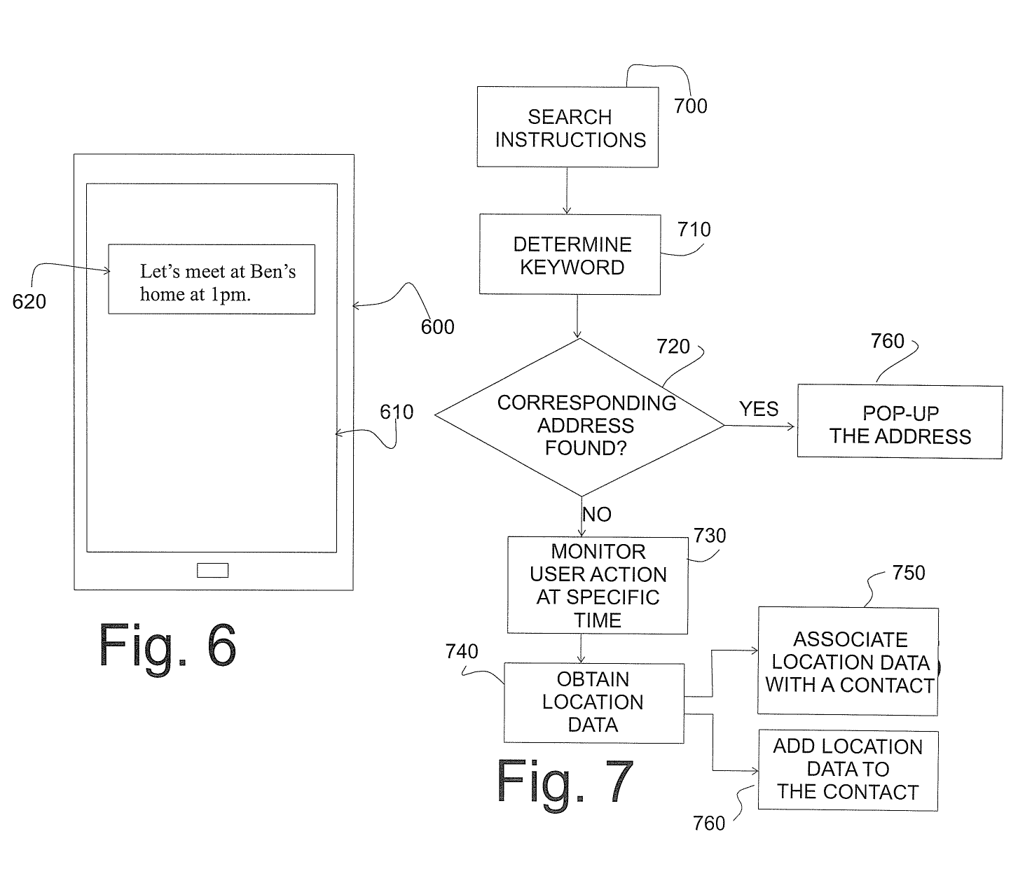

One of the use cases is associating location with contact, as shown in FIG. 6. When a user receives a message (620), e.g. “Let's meet m at Ben's home at 1 pm”, shown on a display (610) of the apparatus (600), the apparatus starts monitoring the clock and at 1 pm, the apparatus is configured to check user's location and store the location information to contact card of “Ben” if “Ben” is already identified in the contact list. If not, the apparatus checks user's location at 1 pm and compares it to all the addresses in the contact list to determine who is “Ben” by means of the checked location. The method steps according to an embodiment is shown in FIG. 7. At first, the apparatus is configured to search instructions (700) (i.e. action request), “meet”. When instructions are found, the apparatus searches keyword(s) (710), such as e.g. “Ben's”, “home”, “1 pm”. “Home” is identified as keyword for address, “Ben” is identified as a keyword for a contact, “1 pm” is identified as keyword for a time. By this information, the apparatus looks (720) for a contact “Ben” and if found, a home address specified there. If found, the apparatus may pop-up the address on the display of the apparatus. If not found, the apparatus monitors (730) user action at the time, which was specified in the message i.e. 1 pm. During the monitoring, the apparatus obtains the location data (740) concerning the user at the specific time. This location data is either associated (750) with contact “Ben” or even added to “Ben's” contact card (760). Either way, next time the user receives a message with similar content, the apparatus is configured to provide the associated location of Ben's for the user.

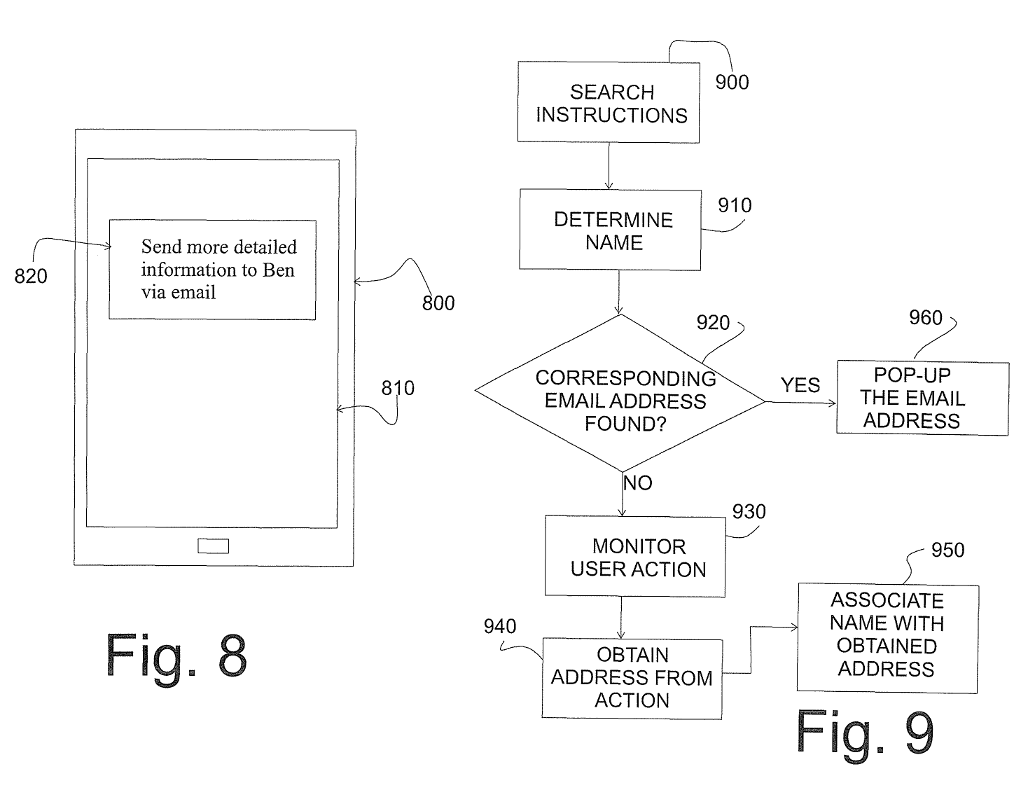

Yet in one other use case, shown in FIGS. 8 and 9, the apparatus (800) is configured to associate an email with a contact. Here, a user receives a message (820) to be shown in the display (810), e.g. “Send more detailed information to Ben via email”. After receiving the message, the apparatus analyzes the message to find instructions (900), i.e. “send . . . email” being the action request. The apparatus determines the keyword, i.e. name “Ben” (910) and starts looking for the contact information of Ben. If the email address is found, the apparatus is configured to pop-up the email address on the display of the apparatus. If the contact information does not contain any email address or if the contact list does not contain “Ben” (920), the apparatus starts monitoring (930) user actions. When the user sends an email to a certain address, the apparatus determines that the email address is Ben's (940) and associates Ben with the obtained email address. Ben's contact card can also be complemented with this email address (950). If the user sends multiple emails, not necessarily the first is determined to be Ben's address. The apparatus may monitor the content of the addresses of the outgoing emails, whereby any address that includes “Ben” or “Benjamin” (retrieved from the contact list) or “Orrel (retrieved from the contact list) is determined to be the exact email address.

Yet, in another use case (not shown in Figures), a message “Send me more information via email.” or “Send it to my email address!” is received. Again, the apparatus is configured to analyze the message to find instructions, i.e. “send . . . . email”. Next, the apparatus determines the keyword, i.e. “me”/“my”, which can be related to the sender of the message. If the email address of the sender is not known, the apparatus performs the association by monitoring the user actions. Therefore, the address of the next outgoing email, or the address of such outgoing email that contains a part of the sender's name in the address, is associated to be the sender's email address. Thus, next time the user receives a message from a server to send something via email to him/her, the apparatus can pop-up the correct email address to the user.

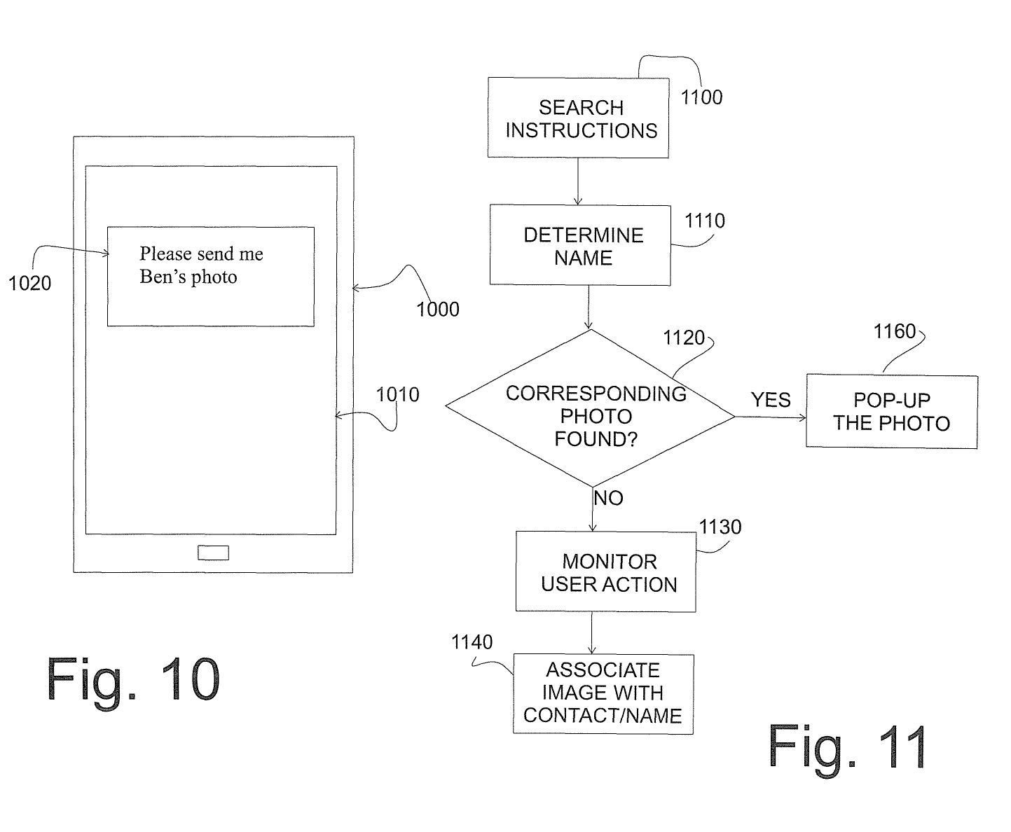

Yet in one other use case, shown in FIG. 10, the apparatus (1000) is configured to associate a photo with a contact. When a user (user A) receives a message (1020) “Please send me Ben's photo” from user B, and the user A replies with a picture named “pic01.jpg” (either recently captured or previously stored) as an attachment, both of the apparatuses become aware that “pic01.jpg” is Ben's picture, because both of the apparatuses were able to make the association by means of the message. This photo can then be added to the contact card of Ben in both devices. For carrying this out, the apparatus searches instructions (1100), i.e. “send . . . photo” (an action request), from the message. Then the apparatus determines the name, or other keyword or identification for the photo (1110), i.e. “Ben”. if the apparatus does not contain any image having a name “Ben” (1120), the apparatus begins to monitor user′ actions to find out, which photo is of Ben. When the user replies to the received message, it is determined that any attached image(s) is an image of Ben. Therefore, this/these image(s) can be associated for a contact or name “Ben” (1140). Ben's contact card may also be amended accordingly.

Further, if a user C sends a message “Please send me Ben's photo” to either user A (or user B), the apparatus of user A is able to attach “pic01.jpg” to the reply message, because name “Ben” was already associated with “pic01.jpg”. Therefore, there is no need to browse the image gallery once again.

Yet in one other user case (not shown in drawings), the apparatus is configured to associate music file to a text string appearing in the message. When a user receives a message “Please send me the song <poker face>”, the apparatus is configured to monitor the action where the user selects file “pf.mp3”. The name “poker face” can thus be associated to file “pf.mp3”. By this, both devises are aware that “pf.mp3” is the song “poker face”. The device may also modify the name of “ph.mp3” with a correct name “poker face” to become “pokerface.mp3”.

In the previous, the apparatus is configured to associate a named element in a message to a data item in the receiving apparatus, whereby next time the same named element appears in a message, the apparatus is configured to obtain the same data item.

The basic operation includes analyzing the message to find out an named element, monitoring actions of the user of the receiving apparatus to determine a data item for the named element and associating the named element to the data item.

This basic operation can be expanded further so that the identity of the sending user also matters. For example, user A has two contacts having name “Ben” (e.g. “Ben1” and “Ben2”). User A receives a message “Call Ben” from user B, whereby the action of the user A is monitored to find out which Ben is meant in the message. When the user A selects “Ben2” as a target for a call, the apparatus is able to defined that “Ben2 is shared by user B and user A”, whereby next time the user B sends a message “Call Ben” to user A, the apparatus is able to automatically retrieve the phone number of “Ben2”.

The similar approach can be applied to e.g. music files. When user A receives a message “Please send me our song” from user B, and user A goes through the media files to select “wmlw.mp3” to be attached to the reply message, the apparatus is configured to define that a media file “wmlw.mp3” is “our song”, i.e. shared song for users A and B. Now, next time, e.g. for anniversary, user A receives a message “Happy Anniversary! Listen our song” from user B, the apparatus is able to automatically open the media player in order to play “wmlw.mp3” i.e. “When a man loves a woman” by means of information that “our song” for user-pair A-B is “wmlw.mp3”.

The association data (e.g. named data element in the message) for the actual data item on the apparatus can be stored to the metadata of the data item, e.g. “shared song for user A and user B” or to the data item, e.g. “Nickname: Ben”, “Email address: Ben@here.com” or as a new name of the data item, e.g. “Pokerface.mp3”, “Ben.jpg”. However, as a result of the association, the additional data is available for future messages and the content therein.

Therefore, next time user receives a message “Call Ben right now”, the name “Ben” is highlighted in the message, and when the user clicks, taps or selected in any other way name “Ben”, a notification is popped up with information of the associated contact, e.g. “Benjamin Orrel (875 5462 45)”. Now the user is able to select an action “call” from a corresponding e.g. icon or “create message” to send a short message to Benjamin instead.

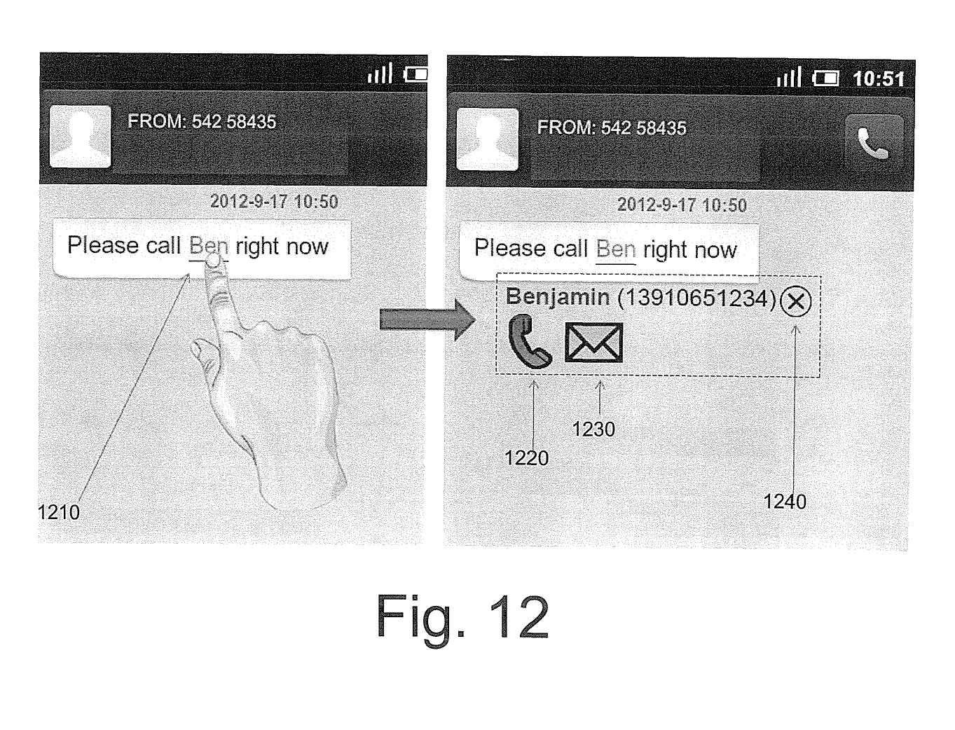

FIG. 12 illustrates an example of such a popup view. Here, a message “Please call Ben right now” is received from a number “542 58435”. A user selects “Ben” (1210) from the message, whereby a pop up view is opened with information “Benjamin (13910651234)” and icons for performing a call (1220) or sending a message (1230). In addition, the pop-up comprises means (1230) to close the pop-up view if the association was incorrect.

If the pop-up contains a wrong contact, the user is able to close the pop-up window.

In the previous, the different use cases were presented as separate actions performed by the apparatus. It is however appreciated these use cases represent different functions of the analysis program.

The various embodiments of the invention can be implemented with the help of computer program code that resides in a memory and causes the relevant apparatuses to carry out the invention. For example, a device may comprise circuitry and electronics for handling, receiving and transmitting data, computer program code in a memory, and a processor that, when running the computer program code, causes the device to carry out the features of an embodiment.

It is obvious that the present invention is not limited solely to the above-presented embodiments, but it can be modified within the scope of the appended claims.

1-26. (canceled)

27. A method, comprising:
receiving a message;
identifying an action request from the message;
determining a keyword from the message;
monitoring the requested action, and detecting a data item relating to the action;
associating the keyword with the detected data item.

28. The method according to claim 27, wherein when a keyword is determined from the message, a data item matching to the keyword is looked for, and if not found, the requested action is monitored to perform the association.

29. The method according to claim 28, wherein if a data item matching the keyword is found, the method comprises:
providing automatically means to perform said action with the data item.

30. The method according to claim 27, wherein the action request relates to one of the following actions: call, send, reply, meet, go, see, and email.

31. The method according to claim 27, wherein the keyword is a character string.

32. The method according to claim 27, wherein the data item is one of the following: a piece of information in a contact card, a media file, and a location.

33. The method according to claim 27, further comprising storing the keyword as an associating data to a metadata of the data item.

34. The method according to claim 27, wherein the message is one of the following: short message, multimedia message, instant message, email, and voice mail.

35. An apparatus comprising at least one processor, memory including computer program code, the memory and the computer program code configured to, with the at least one processor, cause the apparatus to perform at least the following:
receive a message;
identify an action request from the message;
determine a keyword from the message;
monitor the requested action, and detecting a data item relating to the action; and
associate the keyword with the detected data item.

36. The apparatus according to claim 35, wherein when a keyword is determined from the message, the apparatus is caused to look for a data item matching to the keyword, and if not found, to monitor the requested action perform the association.

37. The apparatus according to claim 36, wherein if a data item matching the keyword is found, the apparatus is caused to:
provide automatically means to perform said action with the data item.

38. The apparatus according to claim 35, wherein the action request relates to one of the following actions: call, send, reply, meet, go, see, and email.

39. The apparatus according to claim 35, wherein the keyword is a character string.

40. The apparatus according to claim 35, wherein the data item is one of the following: a piece of information in a contact card, a media file, and a location.

41. The apparatus according to claim 35, further comprising computer program code configured to, with the processor, cause the apparatus to perform at least the following:
storing the keyword as an associating data to a metadata of the data item.

42. The apparatus according to claim 35, wherein the message is one of the following: short message, multimedia message, instant message, email, voice mail.

43. A computer program product embodied on a non-transitory computer readable medium, comprising computer program code configured to, when executed on at least one processor, cause an apparatus or a system to:
receive a message;
identify an action request from the message;
determine a keyword from the message;
monitor the requested action, and detecting a data item relating to the action; and
associate the keyword with the detected data item.

44. The computer program product according to claim 43, wherein when a keyword is determined from the message, the computer program code is configured to cause an apparatus or a system to look for a data item matching to the keyword, and if not found, to monitor the requested action to perform the association.

45. The computer program product according to claim 44, wherein if a data item matching the keyword is found, the computer program code is configured to cause an apparatus or a system to provide automatically means to perform said action with the data item.

46. The computer program product according to claim 43, wherein the action request relates to one of the following actions: call, send, reply, meet, go, see, and email.
